(19) United States
(12) Patent Application Publication
(10) Pub. No.: US 2014/0145843 A1
(43) Pub. Date: May 29, 2014

(54) FIRE EXTINGUISHING DEVICE FOR A SECURITY SYSTEM

(71) Applicants: Laurent Pichard, Frichemesnil (FR); Stephane Di Marco, Cergy (FR); Jacques Lewiner, Saint-Cloud (FR)

(72) Inventors: Laurent Pichard, Frichemesnil (FR); Stephane Di Marco, Cergy (FR); Jacques Lewiner, Saint-Cloud (FR)

(73) Assignee: Finsecur, Nanterre (FR)

(21) Appl. No.: 14/232,616

(22) PCT Filed: Jul. 24, 2012
(86) PCT No.: PCT/FR2012/000306

§ 371 Date: Feb. 4, 2014

(30) Foreign Application Priority Data
Jul. 12, 2011 (FR) 1102202

(51) Int. Cl. A62C 37/50; G08B 29/14

(52) U.S. Cl. CPC A62C 37/50; G08B 29/145
USPC 340/514; 169/51; 29/428

(57) ABSTRACT

A fire extinguishing device for a security system comprises an extinguisher mount, an interface, a power supply, a working condition verifier, a signaling device. The extinguisher mount configured to support an extinguisher for putting out a fire. The interface configured to connect the fire extinguishing device to a security system control unit over a wireless connection. A power supply for supplying power to the fire extinguishing device. The working condition verifier for detecting an operating fault of the fire extinguishing device. The signaling device for signaling the operating fault of the fire extinguishing device at the location of the fire extinguishing device.

The present invention relates to a fire extinguishing device for a security system, and to a security system. It applies in particular to protection against fire risks in public or private residential, industrial, commercial and leisure buildings and to the detection of operational malfunctions in technical facilities.

Extinguishing devices for extinguishing fires are known. A pressure extinguisher, for example, comprises a tank of extinguishing agent designed to put out the fire, and a pressurized gas cartridge. To use the extinguisher, the user must pierce the cartridge to release the gas in the tank, and then operate a handle of the extinguisher to expel the extinguishing agent.

The extinguishers, which are very important for the safety of goods and people, are positioned in premises at suitable positions. The extinguishers are placed on mounts and, to prevent them being removed for reasons other than those originally intended, they are sometimes attached to the mount by means of a wire, sometimes sealed, which can be broken in cases of real need.

However, and for various reasons, extinguishers can be removed from their mount, which is a serious handicap in terms of safety.

In addition, depending on the nature of the risk to be controlled, these extinguishers can be of various types, for example and in a non-limiting way, they can contain different extinguishing agents such as water, foam, various types of powder, gases such as carbon dioxide, halon, etc.

It is desirable, in certain cases, to be able to check the condition of extinguishing devices in real time. This assumes the installation of an electrical network linked to each extinguisher mount, which is feasible in new premises but very difficult to implement in old premises, taking into account the fact that electrical cables have to be passed to locations where this is sometimes difficult and the very high cost such installations entail.

Fire detection systems are known in which the fire extinguishing devices are connected to the control unit by means of a wireless connection. To ensure reliable and safe monitoring, a high-quality connection between each fire extinguishing device and the control unit is important so as to enable information exchanges. However, the quality of the connection can be degraded because of a loss of electric power at the fire extinguishing device or because of the presence of obstacles in the radio communication path between said fire extinguishing device and the control unit, for example. This can bring about a communications failure between the two elements.

In addition, wireless communications for a fire extinguishing device require high current consumption, which can quickly exhaust the power supply of the extinguishing device.

A power supply or radio communications fault can be very dangerous when a fire breaks out, since the fire extinguishing device would then be unable to communicate with the central monitoring station to inform it of its condition, its presence/absence or its identification.

The aim of the invention in at least one embodiment is to overcome drawbacks of the state of the art and to make improvements.

To this end, according to a first aspect, the present invention envisages a fire extinguishing device for a security system comprising: an extinguisher mount arranged so as to support an extinguisher that can extinguish a fire; an interface arranged so as to link the fire extinguishing device to a management device (also called control unit or central monitoring station) of the security system by means of a wireless connection; supply means to enable the fire extinguishing device to be supplied with electricity from a power source; fault detection means to detect an operating fault in the fire extinguishing device; and signaling means to signal the operating fault in the fire extinguishing device at the location of the fire extinguishing device.

According to a particular embodiment, the detection means are arranged so as to detect a communications fault between the fire extinguishing device and the control unit by means of the wireless connection and the signaling means are arranged to signal said communications fault.

In an embodiment, the detection means are arranged so as to detect a fault in the power supply to the fire extinguishing device from the power source and the signaling means are arranged to signal said power supply fault.

According to an embodiment, the fault detection means are arranged so as to measure a parameter representative of the reception quality of a predefined radio verification signal coming from the control unit. For example, the verification means can be arranged to measure the signal-to-noise ratio or the intensity of the radio verification signal and to compare them to a predefined threshold. Hereinafter, “intensity” will mean any parameter representative of the quality of information transmission by the radio connection, such as the signal's amplitude, phase or frequency modulation, for example.

According to an embodiment, the fault detection means are arranged so as to measure a parameter representative of the quantity of power remaining in the power source.

In an embodiment, the signaling means are arranged so as to generate different signals depending on the operating fault or on the magnitude of this fault.

In an embodiment, the signaling means are arranged so as to emit a sound signal whose frequency varies depending on the operating fault or on the magnitude of this fault.

According to a particular embodiment, the signaling means are arranged so as to emit a sound signal in the form of impulses at repetition frequencies that depend on the quality of the wireless connection between the fire extinguishing device and the central monitoring station or on the quantity of power remaining in the power source.

According to a particular embodiment, the signaling means are arranged so as to emit a light signal whose color varies depending on the type or magnitude of the operating fault.

According to a particular embodiment, the signaling means are arranged so as to emit a blinking light signal whose blink frequency varies depending on the type or magnitude of the operating fault.

According to a particular embodiment, the signaling means are arranged so as to signal the operating fault when a button for testing the fire extinguishing device is pressed.

According to a particular embodiment, the fire extinguishing device is associated to means of detecting the presence of at least one person in the vicinity of the fire extinguishing device, wherein the signaling means are able to signal a visible or audible alarm when the presence of at least one person is detected. For example, the means of detecting persons may comprise a detector of infrared rays from an infrared ray emitter associated with or coming from a person.

In a particular embodiment, the fire extinguishing device comprises means of signaling the operating fault to the control unit.

According to a particular embodiment, the fire extinguishing device comprises extinguisher identifying means designed to obtain identifying data for an extinguisher from an identifying element on the extinguisher; and activation means able to activate the identifying means in response to a predefined event.

According to a particular embodiment, the mount comprises an identifying element for the mount to supply the central monitoring station with identifying data for the mount allowing the mount to be identified.

According to a particular embodiment, the identifying means are arranged so as to communicate with the identifying element of the extinguisher via a wireless connection in order to verify an identifying code for the extinguisher.

According to a particular embodiment, the identifying means comprise a device for identification by RF.

According to a particular embodiment, the identifying means comprise an optical reader and image processing means for processing an image coming from the optical reader.

According to a particular embodiment, the optical reader comprises a linear network of diodes, a two-dimensional optical sensor, a camera, or a laser.

According to a particular embodiment, the activation means are able to activate the identifying means at predefined times.

According to a particular embodiment, the activation means are able to activate the identifying means in response to an interrogation signal from the central monitoring station.

According to a particular embodiment, the extinguishing device comprises means of detecting the absence of an extinguisher from its operating position.

According to a particular embodiment, the signaling means are configured so as to signal said absence of the extinguisher at the location of the extinguisher identifying device.

According to a second aspect, the present invention envisages a security system comprising at least one fire extinguishing device according to the first aspect of the invention and a central monitoring station able to be connected by means of a wireless connection to said set of at least one fire extinguishing device.

For this purpose, according to a third aspect, the present invention envisages a fire extinguishing device for a security system, the fire extinguishing device comprising: an extinguisher mount arranged so as to support an extinguisher that can extinguish a fire; an interface arranged so as to link the fire extinguishing device to a management device (often called control unit or central monitoring station) of the security system by means of a wireless connection; means of verifying the quality of the wireless connection so as to verify, during a step of installing the fire extinguishing device, the quality of the wireless connection between said fire extinguishing device and the management device; and signaling means to signal an indication of the quality of the wireless connection between said fire extinguishing device and the management device during the installation step of said fire extinguishing device.

According to an embodiment, the verification means are arranged so as to measure a parameter representative of the reception quality of a predefined radio verification signal coming from said management device.

According to an embodiment, the verification means are arranged to measure the signal-to-noise ratio or the intensity of the predefined radio verification signal. Hereinafter, “intensity” will mean any parameter representative of the quality of information transmission by the radio connection, such as the signal's amplitude, phase or frequency modulation, for example.

Hereinafter, the expression “quality of the connection to the fire extinguishing device” will refer to the relative value of the signal-to-noise ratio or of the intensity of the predefined radio verification signal received from the management device in relation to a reference value.

Similarly, hereinafter, the expression “quality of the connection to the management device” will refer to the relative value of the signal-to-noise ratio or of the intensity of a predefined radio verification signal received from the fire extinguishing device in relation to a reference value.

Lastly, hereinafter, the expression “quality of the radio connection” will refer either to the relative value of the signal-to-noise ratio or of the intensity of a predefined radio verification signal received from the fire extinguishing device or from the management device in relation to a reference value.

According to an embodiment, the signaling means are arranged so as to generate different signals depending on the reception quality of the predefined verification signal.

According to an embodiment, the signaling means are arranged so as to emit a sound signal whose frequency or volume varies depending on the quality of the connection towards the fire extinguishing alarm device.

According to an embodiment, the signaling means are arranged so as to emit a light signal whose color or intensity varies depending on the quality of the connection to the fire extinguishing device.

According to an embodiment, the signaling means are arranged so as to emit a blinking light signal whose blink frequency varies depending on the quality of the connection to the fire extinguishing device.

According to an embodiment, the signaling means are arranged so as to emit a sound signal in the form of impulses whose impulse repeat frequency varies depending on the quality of the connection to the fire extinguishing device.

According to an embodiment, the impulse repeat frequency increases depending on the increase in quality of the connection to the fire extinguishing device.

According to an embodiment, the verification means are arranged so as to emit a test radio signal towards the management device; to wait, for a predefined period of time, for a response radio signal from the management device; and to measure the intensity or the signal-to-noise ratio of the radio response, if a response signal is received.

According to an embodiment, the device can also comprise emission means to emit a predefined verification radio signal to the management device to allow the management device to check the quality of the wireless connection between the management device and the fire extinguishing device during the installation step of the triggering device.

A fourth aspect of the invention envisages a security system comprising a management device able to communicate with at least one fire extinguishing device as described above.

A fifth aspect of the invention envisages an installation method for at least one fire extinguishing device of a security system in an area to be monitored, with the security system comprising a management device able to communicate with the fire extinguishing device by means of a wireless connection, the method comprising the following steps:
positioning the fire extinguishing device at a first location;
checking the quality of the wireless connection between the fire extinguishing device at the first location and the management device;
signaling, at the location of the fire extinguishing device, an indication of the quality of the wireless connection between said fire extinguishing device and the management device; and
moving the fire extinguishing device to a second location within the area to be monitored to check if the quality of the wireless connection can be improved.

According to an embodiment, the verification step comprises a step of measuring a parameter representative of a predefined radio verification signal coming from said management device.

According to an embodiment, the verification step comprises a step of measuring the signal-to-noise ratio or the intensity of the predefined radio verification signal.

According to an embodiment, the signaling step comprises generating different signals depending on the reception quality of the predefined verification signal.

According to an embodiment, the signaling step comprises emitting a sound signal whose frequency or volume varies depending on the quality of the connection to the management device.

According to an embodiment, the signaling step comprises emitting a light signal whose color or intensity varies depending on the quality of the connection to the fire extinguishing device.

According to an embodiment, the signaling step comprises emitting a blinking light signal whose blink frequency varies depending on the quality of the connection to the fire extinguishing device.

According to an embodiment, the signaling step comprises emitting a sound signal in the form of impulses whose impulse repeat frequency varies depending on the quality of the connection to the fire extinguishing device.

According to an embodiment, the impulse repeat frequency increases depending on the increase in quality of the connection to the fire extinguishing device.

According to an embodiment, the verification step comprises:
transmitting a test signal towards the management device;
waiting, for a predefined period of time, for a response signal from the management device; and
measuring the intensity or the signal-to-noise ratio of the response, if a response signal is received.

Another aspect of the present invention proposes a computer program for implementing at least part of the corresponding method described previously. Such a program may be downloadable from a telecommunications network and/or stored in a memory of a processing device and/or stored on a memory medium designed to cooperate with a processing device.

According to a sixth aspect, the present invention envisages a fire extinguishing device for a security system comprising: an extinguisher mount arranged so as to support an extinguisher that can extinguish a fire; an interface arranged so as to link the fire extinguishing device to a management device (also called control unit or central monitoring station) of the security system by means of at least a wireless connection; supply means to enable the fire extinguishing device to be supplied with electricity from a power source; communications verification means to detect the absence of communications with the management device during a predefined length of time; and signaling means to signal said absence of communications at the location of the fire extinguishing device.

According to an embodiment of the invention, the fire extinguishing device comprises means for checking the operating condition of the fire extinguishing device and fault communications means so as to signal information representative of the operating condition to the management device.

According to an embodiment of the invention, the fire extinguishing device comprises response means able to detect the reception of an interrogation signal coming from the management device and, in response to the reception of the interrogation signal, to transmit information representative of the operating condition of the fire extinguishing device to the management device.

According to an embodiment of the invention, the operating condition verification means are arranged so as to verify the power status of the fire extinguishing device.

According to an embodiment of the invention, the operating condition verification means are arranged so as to measure a parameter representative of the quantity of power remaining in the power source.

According to an embodiment of the invention, the operating condition verification means are arranged so as to verify the condition of the wireless connection with the management device.

According to an embodiment of the invention, the operating condition verification means are arranged so as to measure a parameter representative of the reception quality of a predefined radio verification signal coming from said management device.

According to an embodiment of the invention, the operating condition verification means are arranged to measure the signal-to-noise ratio or the intensity of the predefined radio verification signal. Hereinafter, “intensity” will mean any parameter representative of the quality of information transmission by the radio connection, such as the signal's amplitude, phase or frequency modulation, for example.

According to an embodiment of the invention, the fire extinguishing device comprises means of detecting a presence of at least one person in the vicinity of the fire extinguishing device, wherein the signaling means are able to signal a visible or audible alarm when the presence of a person is detected.

According to an embodiment of the invention, the detection means comprise a detector of infrared rays coming from an emitter of infrared rays associated with or coming from a person.

A seventh aspect of the invention envisages a security system comprising a management device able to be linked via a wireless connection to at least one fire extinguishing device according to the first aspect of the invention and also comprising interrogation means to send an interrogation signal to said at least one fire extinguishing device so as to obtain information representative of the operating condition of the triggering device.

An eighth aspect of the invention envisages a monitoring method for a security system comprising a management device and at least one fire extinguishing device able to communicate with the management device by means of a wireless connection, the method comprising a step of verifying the wireless connection to detect the absence of communications from the management device to the fire extinguishing device during a predefined length of time; and a signaling step to signal said absence of communications at the location of the fire extinguishing device.

In a particular embodiment, the method comprises the detection of the reception of an interrogation signal coming from the management device, and, in response to the reception of the interrogation signal, the transmission of a response signal to the management device.

In a particular embodiment, the method comprises the detection of the reception of an interrogation signal coming from the management device, and, in response to the reception of the interrogation signal, the transmission of a response signal to the management device and, in response to the reception of the response signal by the management device, the transmission of a confirmation signal to the management device.

In a particular embodiment, the method comprises the repetition in time of sequences of events described above.

In a particular embodiment, the method comprises the detection of the reception of an interrogation signal coming from the management device, and, in response to the reception of the interrogation signal, the transmission of information representative of the operating condition of the fire extinguishing device to the management device.

The predefined period of time can be chosen according to the period of time between the interrogation signals. For example if the period of time between two interrogation signals is 12 hours, the predefined period of time can be chosen to be greater than 12 hours. If in this case, for example, the predefined period of time is chosen to be 24 hours, the alarm device would be arranged so as to signal an absence of communications when it had not received two successive interrogation signals. Of course, the above values are only given as an example. Depending on the premises protected by the management device, these values can be different and, in particular, lower.

In a particular embodiment, the opening frequency of windows in which the fire extinguishing device listens for an interrogation signal is chosen according to the emission frequency of the interrogation signal by the management device.

In a particular embodiment, the opening times of windows in which the fire extinguishing device listens for an interrogation signal are chosen according to the emission times of the interrogation signal by the management device.

In the following, descriptions are provided for some preferred embodiments of the invention with reference to the figures in an appendix hereto, in non-limiting fashion, of course.

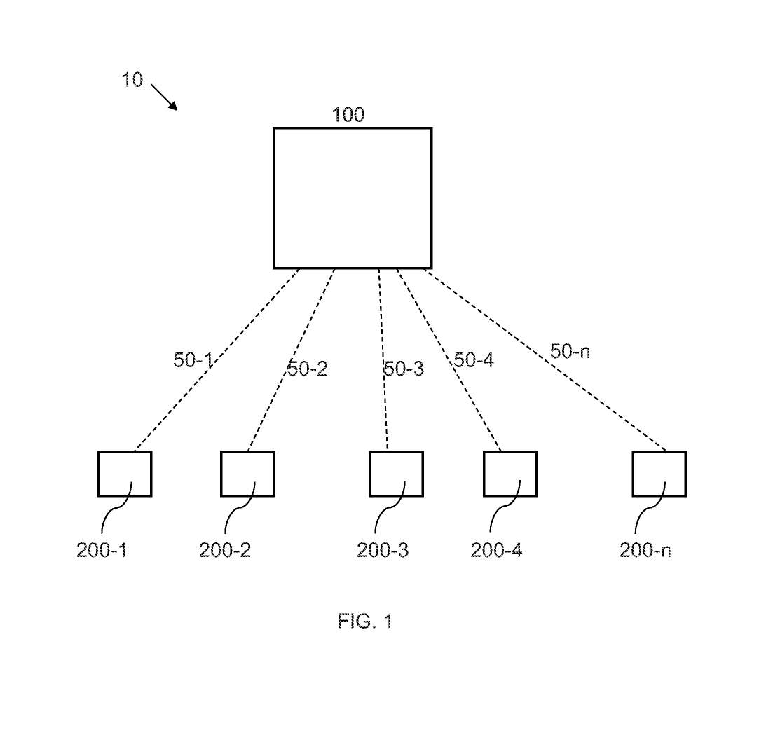

FIG. 1 is a schematic representation of elements of a security system according to a first embodiment of the present invention.

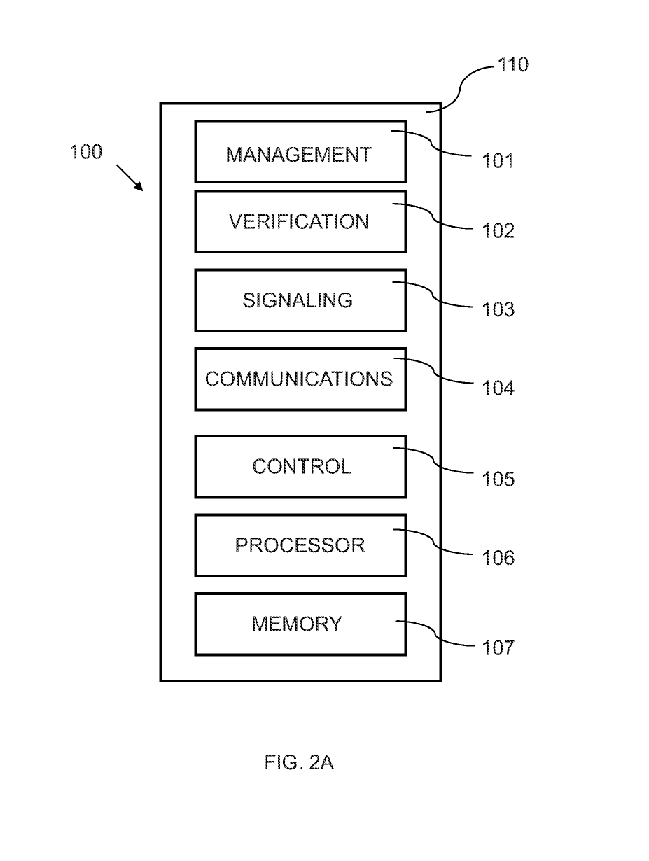

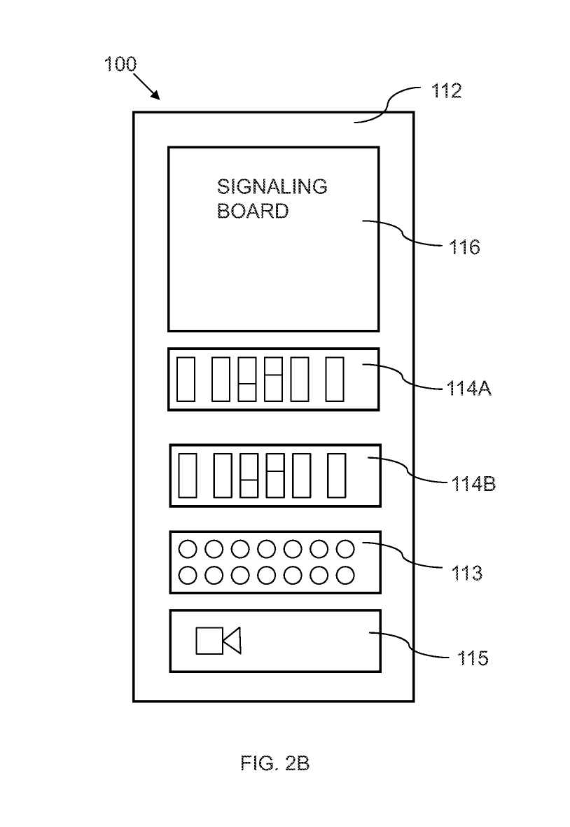

FIG. 2A is a schematic representation of a central monitoring station according to at least one embodiment of the invention.

FIG. 2B is a schematic representation of the front face of a central monitoring station housing according to a first embodiment of the invention.

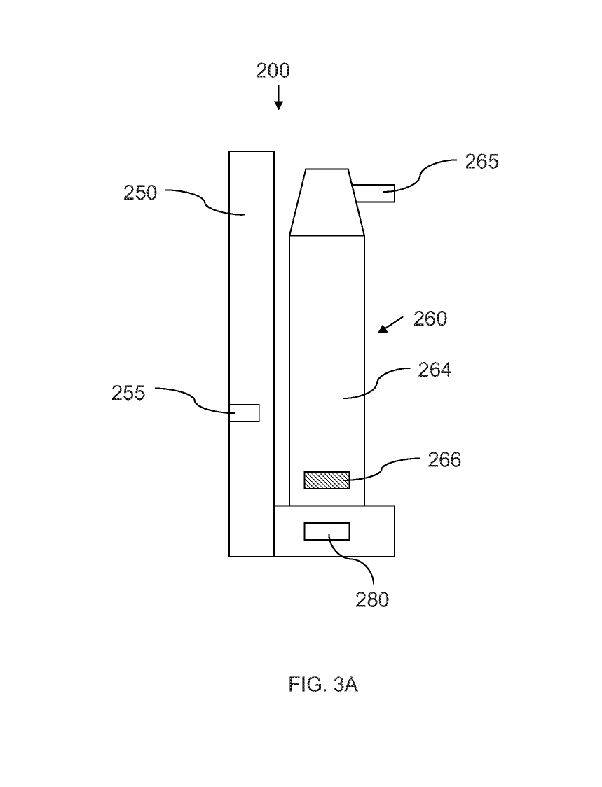

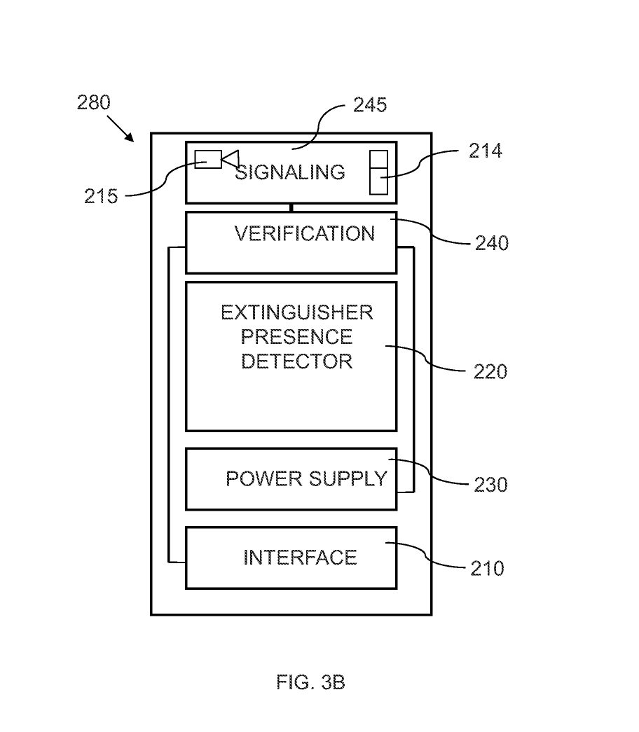

FIG. 3A is a schematic representation of a fire extinguishing device according to at least one embodiment of the invention.

FIG. 3B is a schematic representation of a device for detecting the presence of an extinguisher according to a first or second embodiment of the invention.

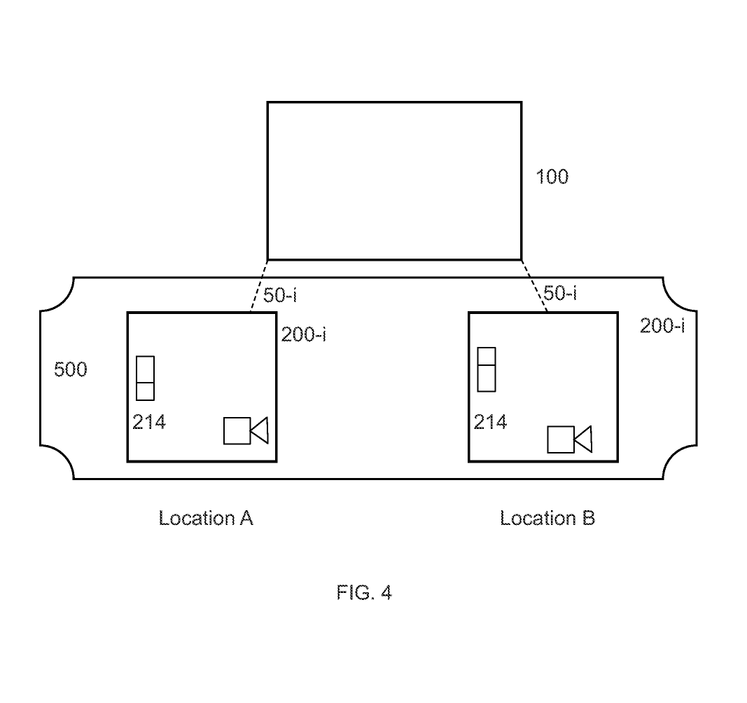

FIG. 4 is a schematic representation of a method for positioning a fire extinguishing device according to an embodiment of the invention.

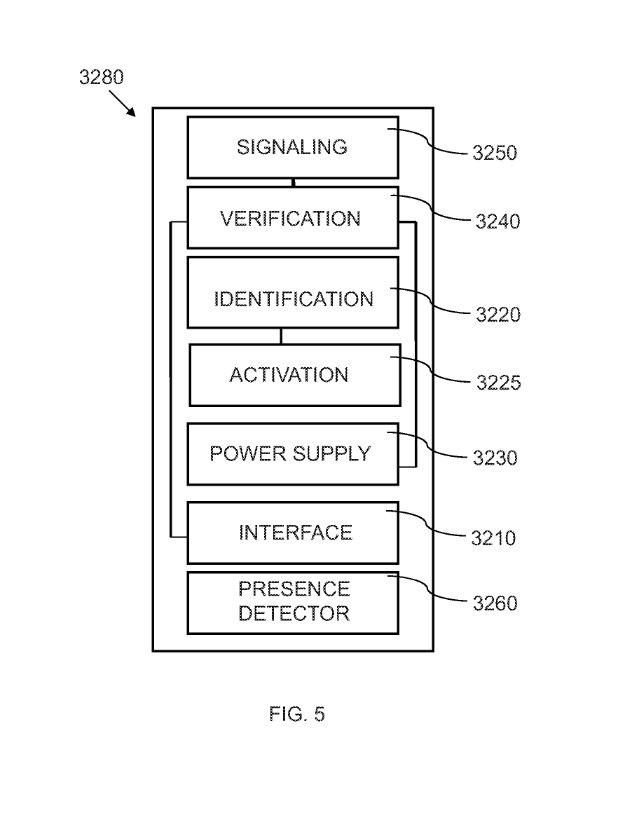

FIG. 5 is a schematic representation of an extinguisher identifying device according to a third embodiment of the invention.

A security system 10 according to at least one embodiment of the invention is represented schematically in FIG. 1. This security system comprises an electronic central monitoring station 100, connected to several fire extinguishing devices 200-1 . . . 200n distributed in an area to be monitored by means of the wireless connections 50-1 . . . 50-n.

In the embodiment shown in FIG. 2A, the central monitoring station 100 is realized with a single housing 110 that groups together a set of computerized means of management 101, of verification 102 for verifying the condition of the wireless connections 50-1 . . . 50-n between the central monitoring station 100 and the fire extinguishing devices 200, of signaling 103, of communications 104 and of control 105. The central monitoring station 100 also comprises a processor 106 to manage these means and memory 107 to store the data.

The central monitoring station 100 is configured, in a way known per se, so as to receive information sent by fire extinguishing devices 200-1 . . . 200-n, signal an alarm condition or fault by visual and/or audible means and to control said fire extinguishing devices 200-1 . . . 200-n. The communication means 104 comprise a wireless interface including a device for receiving and transmitting radio signals, equipped with an antenna to allow the central monitoring station 100 to communicate with the fire extinguishing devices 200-1 . . . 200-n via wireless connections 50-1 . . . 50-n.

The verification means 102 are connected to the wireless interface 104 and are configured to send an interrogation signal to fire extinguishing device 200-i so as to receive from the fire extinguishing device information representative of the operating condition of said fire extinguishing device 200-i. The information representative of the operating condition of said fire extinguishing device 200-i can comprise the information representative of the condition of the wireless connection 50-i between the central monitoring station 100 and the fire extinguishing device 200-i and/or the condition of the electrical supply device of the fire extinguishing device 200-i, for example a cell or a battery.

In a particular embodiment of the invention, the verification means 102 are configured so as to verify, at the central monitoring station 100, the condition of the wireless connection 50-i between the central monitoring station 100 and the fire extinguishing device 200-i. To this end, the verification means 102 can be configured so as to measure the intensity of the radio response signal received from the fire extinguishing device 200-i through the wireless interface 50-i and to compare the measured intensity with a predefined intensity threshold. The verification means 102 can be configured so as to measure, as an alternative or in addition, the signal-to-noise ratio of the radio signal received from the fire extinguishing device 200-i through the wireless interface 50-i and to compare this measured signal-to-noise ratio to a predefined signal-to-noise ratio threshold.

FIG. 2B shows the front face 112 of the housing 110 of the central monitoring station 100 comprising alarm indicators 113, each of which represents, in a manner known per se, the alarm status of a corresponding fire extinguishing device 200 of the monitoring system. The front face 112 also comprises operating indicators 114A, 114B, each of which indicates the operating condition of the corresponding fire extinguishing device, a sound emitter 115, and a display screen 116. The sound emitter 115 is of a type known, for example, in fire alarms and is designed to emit an audible alarm signal. Each operating indicator 114n can correspond to a different fire extinguishing device 200n.

The display screen 116 allows the central processor to display visual messages aimed at a user of the central fire monitoring station 100 and/or at a member of the maintenance team for this device. In particular, the display screen 116 is designed to display an alarm indication and/or an indication of the operating condition of one or more fire extinguishing devices 200.

In this embodiment, the signaling means 103 are configured so as to generate different signals depending on the operating condition of the fire extinguishing device. For example, the signaling means 103 can be configured to manage the light emission of an operating indicator 114A such that the color of the operating indicator 114A varies depending on the intensity or the signal-to-noise ratio of the verification or response signal received from the triggering device and to manage the light emission of an operating indicator 114B such that the color of the operating indicator 114B varies depending on the remaining power level in the power supply battery of the corresponding fire extinguishing device.

In variants, the brightness of the light from the indicator 114A or 114B can vary depending on the intensity or on the signal-to-noise ratio of the verification or response signal received; or on the remaining power level in the power supply battery. In other variants, the signaling means 103 can be configured to manage the blink frequency of the indicator 114A or 1148 depending on the intensity or the signal-to-noise ratio of the verification or response signal received and/or on the remaining power level in the power supply battery. In an embodiment, the operating indicator 114A, 114B can comprise several emission elements and the number of emission elements lit can vary depending on the intensity or the signal-to-noise ratio of the verification or response signal received and/or on the remaining power level in the power supply battery.

In other variants, the signaling means 103 can generate a sound signal, for emission by the sound emitter 115, whose volume or frequency varies depending on the intensity or the signal-to-noise ratio of the verification or response signal received and/or on the remaining power level in the power supply battery.

In some embodiments, information concerning the operating condition of the fire extinguishing device may be displayed on the signaling board 116 of the central monitoring station 100.

A fire extinguishing device 200 for the security system, according to at least one embodiment of the invention, is represented schematically in FIG. 3A.

The fire extinguishing device 200 comprises an extinguisher mount 250, an extinguisher 260 and an extinguisher presence detection device 280. The extinguisher mount 250 is designed in a manner known per se to support an extinguisher 260.

The extinguisher 260 is a pressure extinguisher, which comprises a tank 264 containing an extinguishing agent that makes it possible to put out a fire and a pressurized gas cartridge. To use the extinguisher, the user must pierce the cartridge to release the gas in the tank 264, and then operate a handle 265 of the extinguisher 260 to expel the extinguishing agent. The extinguishing agent can comprise, for example, water, foam, various types of powder, gases such as carbon dioxide, halon, etc.

With reference to FIG. 3B, the extinguisher presence detection device 280 according to a first embodiment of the invention comprises a wireless interface 210 to link the fire extinguishing device 200 to the central monitoring station 100 of the fire detection system by means of the wireless connection 50; an extinguisher presence detector 220; a power supply battery 230 to power the fire extinguishing device 200; a working condition verifier 240 for detecting an operating fault of the fire extinguishing device 200; and a signaling device 245 able to signal the operating fault in the fire extinguishing device detected by the working condition verifier 240, at the location of the fire extinguishing device 200. In a particular embodiment, the signaling device 250 can be able to signal an alarm signal in case of an operating fault when a test button is operated.

The detector of the presence/absence 220 of an extinguisher 260 from its mount 250 can be realized in any known way. This can be, for example, by using an electrical contact that is closed when the extinguisher 260 is in its mount 250 and open when the extinguisher 260 is not in its mount 250. Of course, it is possible to have the electrical contact open when the extinguisher 260 is in its mount and closed when not in it. This can also be by using any system utilizing a magnetic field. In that case, a magnet that creates a permanent magnetic field is fixed to the extinguisher 260 and cooperates with a flexible plate switch (reed switch) or a Hall effect circuit fixed on the mount. Or again, this can be a system wherein electrodes fixed respectively on the extinguisher and on the mount cooperate to form a capacitor.

The working condition verifier 240 is connected to the wireless interface 210 and to the battery 230. It is configured so as to make it possible to detect an absence of wireless communications with the central monitoring station 100 and to detect a power supply fault at the fire extinguishing device from the battery 230. For this purpose, the working condition verifier 240 can be configured so as to measure the intensity of the radio signal received from the control unit through the wireless interface 50 and to compare it with a predefined intensity threshold. In another embodiment the working condition verifier 240 can be configured so as to measure the signal-to-noise ratio of the radio signal received from the control unit through the wireless interface 50 to compare it to a predefined signal-to-noise ratio threshold. In a particular embodiment, the working condition verifier can be configured so as to send a test signal to the central monitoring station 120 and to wait for a response signal coming from the control unit 120 so as to verify the wireless connection 50. Failure to receive a response or receiving a response signal with low intensity may indicate a faulty wireless connection. In other embodiments, communications radio signals can be transmitted from the central monitoring station 120 towards the fire extinguishing device on a regular basis. Failure to detect these signals or detecting signals with low intensity can trigger the signaling means 250 to generate a malfunction alarm signal.

In a second embodiment the working condition verifier 240 can be configured so as to send a test signal to the central monitoring station 100 during the installation of the fire extinguishing device 200 and to wait for a response signal coming from the central monitoring station 100 so as to verify the wireless connection 50. The intensity and/or the signal-to-noise ratio of the response signal coming from the central monitoring station 100 can then be measured to determine the quality of the wireless connection 50-i between the central monitoring station 100 and the fire extinguishing device 200-i. When weak intensity and/or a weak signal-to-noise ratio is detected, the fire extinguishing device 200-i can be moved to another location within the area to be monitored so as to improve the quality of the wireless connection 50-i. The absence of a response signal from the central monitoring station 100 may indicate the absence of wireless communications. In this case, the fire extinguishing device 200-i can be moved within the area to be monitored so as to find a location that allows improved wireless communications between the two devices.

In this embodiment, the signaling means 245 are configured so as to generate different signals depending on the reception quality of the verification or response radio signal coming from the central monitoring station 100. For example, the signaling means 245 can be configured to manage the light emissions of an indicator 214 representative of the quality of the connection such that the color of the power supply indicator varies depending on the intensity or the signal-to-noise ratio of the verification or response signal received from the central monitoring station.

In variants, the brightness of the light from the indicator 214 can vary depending on the intensity or the signal-to-noise ratio of the verification or response signal received. In other variants, the signaling means 245 can be configured to manage the indicator's blink frequency depending on the intensity or the signal-to-noise ratio of the verification or response signal received. In an embodiment, the indicator can comprise several emission elements and the number of emission elements lit can vary depending on the intensity or the signal-to-noise ratio of the verification or response signal received.

In other variants, the signaling means 245 can generate a sound signal whose volume or frequency varies depending on the intensity or the signal-to-noise ratio of the verification or response signal received.

Different sounds can be emitted depending on the quality of the wireless connection 50 or the emission frequency of these sounds can vary depending on the quality of the wireless connection 50 or these sounds can be emitted in the form of impulses at repeat frequencies that depend on the quality of the wireless connection 50. In a particular embodiment, the repeat frequency increases depending on the improvement in the quality of the wireless connection. In another embodiment the repeat frequency decreases depending on the improvement in the quality of the wireless connection.

It should be noted that the device described above makes it possible to facilitate the installation of fire extinguishing devices. In effect, once the control unit has been installed, it is possible to place the fire extinguishing devices in positions such that the signaling means are not in a malfunction alarm condition. For example, if they are arranged so as to emit a sound signal in the form of impulses at repeat frequencies that get correspondingly lower as the radio connection's quality decreases, then the person installing the fire extinguishing device has a directly perceptible piece of information. It would, of course, be possible to emit impulses at repeat frequencies that get correspondingly higher as the radio connection's quality decreases.

With reference to FIG. 4, during the installation of a fire extinguishing device 200-i in the area to be monitored 500, the quality of the connection 50-i between the fire extinguishing device 200-i and the central monitoring station 100 is first checked when the fire extinguishing device 200-i is placed at position A. To achieve this the fire extinguishing device 200 transmits a test signal to the central monitoring station 100 and waits, for a predefined period of time, for a response signal from the central monitoring station 100. The intensity and/or the signal-to-noise ratio of the response signal from the central monitoring station 100 is measured and compared to a predefined threshold to determine the quality of the wireless connection 50-i between the central monitoring station 100 and the fire extinguishing device 200-i. A display 214, representative of the quality of the connection on the fire extinguishing device, lights a number of light elements depending on the intensity of the response signal received. When weak intensity and/or a weak signal-to-noise ratio or an absence of response signal is detected, the fire extinguishing device 200-i is moved from location A to another location within the area to be monitored 500 and the wireless connection 50-i is checked in the same way to determine whether the quality of the connection at location B has been improved in comparison with the quality of the wireless connection 50-i achieved at location A. The display 214, representative of the quality of the connection, lights more or fewer light elements depending on the intensity of the response signal received from the central monitoring station 100 when the fire extinguishing device is at location B. In this way, the fire extinguishing device 200-i may be placed at several locations so as to find a location among several locations within the area to be monitored 500 that enables optimum wireless communication with the central monitoring station 100. This method can be repeated for the installation of each fire extinguishing device. The ability to test the wireless connection at the time of installation makes it possible to optimize the positioning of each fire extinguishing device within the area to be monitored. Consequently, the installer of the fire extinguishing device is informed of the quality of the wireless connection at the time of the installation.

An extinguisher identifying device 3280 for a fire extinguishing device according to a third embodiment of the invention is represented schematically in FIG. 5. The extinguisher identifying device comprises a wireless interface 3210 to link the fire extinguishing device (200-3200) to the central monitoring station 100 of the fire detection system by means of the wireless connection 50; extinguisher identifying means 3220 for identifying the extinguisher 250 on the mount 260; a power supply battery 3230 to power the fire extinguishing device (200-3200); a communications verification processor 3240 for detecting an absence of communications from the central monitoring station 100 during a predefined length of time; and a signaling device 3250 able to signal an absence of communications detected by the communications verification processor 3240, at the location of the fire extinguishing device 3200.

The communications verification processor 3240 is connected to the wireless interface 3210 and to the battery 3230. It is configured so as to make it possible to detect an absence of wireless communications with the central monitoring station 100 and to detect an extinguisher power supply fault from the battery 3230. To this effect, the verification processor 3240 can be configured so as to wait, for a predefined period of time, for an interrogation signal from the central monitoring station 100.

The predefined period of time can be chosen according to the period of time between two interrogation signals. For example if the period of time between two interrogation signals is 12 hours, the period of time can be chosen to be greater than 12 hours. If in this case, for example, the predefined period of time is chosen to be 24 hours, the fire extinguishing device can activate its alarm signaling means, if two successive interrogation signals are absent.

In an embodiment, the central monitoring station 100 emits an interrogation signal, for example every 200 seconds during an emission window of 3 seconds to the fire extinguishing devices and these devices are arranged so as to activate their listening means during a 10 ms listening window every 2 seconds.

In this way, there are always overlaps between some of the listening windows and the emission windows.

In order to limit consumption by the control unit, it is possible to space out the interrogation messages and to emit them, for example, every 12 hours. In such a configuration, it is possible to wake up the listening system of the fire extinguishing devices at the intended emission times of interrogation messages by the control unit and, so as to protect against a difference between the internal clocks of the fire extinguishing device and of the control unit, to activate the listening means of the fire extinguishing device during listening windows, for example of 10 ms every 2 seconds during a 1 min period centered on the intended emission times of the control unit.

This makes it possible to ensure that the fire extinguishing device is in the listening position during the emission and to verify the good reception of the interrogation message by the fire extinguishing device. This also makes it possible to resynchronize the internal clock of the fire extinguishing device with that of the control unit so as to avoid a gradual drift of one clock in relation to the other.

In another variant, every 12 hours the control unit emits a message, for example in a time window of more than 3 seconds, towards the fire extinguishing devices and these devices are arranged so as to activate their listening means during a 10 ms listening window every two seconds.

Of course, in order to validate the quality of the radio connection between the fire extinguishing device and the control unit, it is possible, for example, to provide for the communications verification processor 3240, following good reception of the interrogation signal sent by the control unit to the fire extinguishing device, to activate a response to the control unit. If the control unit receives this response, it sends an acknowledgement message back to the fire extinguishing device.

If this acknowledgement message is not received, the fire extinguishing device can either activate its alarm signaling means, or send back to the control unit a second response message to the request and possibly several others in the event of the non-receipt of the acknowledgement message from the control unit.

In general, when the verification processor 3240 detects an absence of message reception during a predefined period of time, as described in the examples above, the signaling device 3250 is utilized so as to signal the communications fault at the location of the fire extinguishing device (200, 3200). In this way, a person in the vicinity of the fire extinguishing device 3200 will be warned of the absence of communications between the fire extinguishing device 3200 and the central monitoring station 100.

In a particular embodiment of the invention, the verification processor 3240 can be configured so as to measure the intensity and/or the signal-to-noise ratio of a radio signal received from the central monitoring station 100 through the wireless interface 50 and to compare it to a predefined intensity and/or signal-to-noise ratio threshold.

In the same way, the verification processor 240 can be configured to measure the remaining power level in the battery 3230 so as to compare it with a predefined threshold. A power level measurement lower than said threshold indicates a power supply operating fault.

These measurements allow the fire extinguishing device to send information concerning its operating condition to the central monitoring station 100 in response to the interrogation signal sent by the central monitoring station 100.

In a particular embodiment of the invention, the extinguisher identifying device 3280 is equipped with a detector of the presence of at least one person 3260. The presence detector 3260 is configured to emit a control signal towards the signaling device to only operate the signaling means 3250 in the presence of at least one person in the vicinity of the fire extinguishing device. Such a collaboration between the presence detector and the signaling means 3250 makes it possible to avoid utilizing signaling means in the absence of a person in its vicinity, which might consume the little power remaining in the power supply battery 3230.

In this embodiment, in a first variant, the detector of the presence of a person 3260 comprises a detector of infrared rays for detecting the infrared rays coming from an associated emitter of infrared rays. The absence of or reduction in the reception of infrared rays coming from the emitter of infrared rays would indicate the presence of one or more persons in the vicinity of the extinguisher. In a second variant, the detector of the presence of at least one person 3260 comprises a detector of infrared rays for detecting the infrared rays coming from one or more persons in the vicinity of the fire extinguishing device. The appearance of these infrared rays would indicate the presence of one or more persons in the vicinity of the fire extinguishing device.

The detector of the presence of at least one person 3260 can be incorporated in the fire extinguishing device 3200 or can be a device separate from the fire extinguishing device and associated with the fire extinguishing device 3200.

In a particular embodiment the communications verification processor 3240 can be configured so as to send a test signal to the central monitoring station 100 and to wait for a response signal coming from the central monitoring station 100 so as to verify the wireless connection 50. Failure to receive a response or receiving a response signal with low intensity may indicate a faulty wireless connection.

In another embodiment, the signaling means 3250 can be configured so as to generate different signals depending on an operating fault of the fire extinguishing device 3200. For example, the signaling means 3250 may comprise a first warning indicator dedicated to communications faults with the central monitoring station and a second warning indicator dedicated to power supply faults. Thus, the first warning indicator emitting a visible signal indicates a communications fault and the second warning indicator emitting a visible signal indicates a power supply fault. In variants, a single indicator can be configured to emit different colors depending on the operating fault or to blink at different frequencies depending on the operating fault. In other variants, a sound signal can be emitted by the signaling means to warn of the operating fault. Different sounds can be emitted depending on the operating fault detected or the emission frequency of these sounds can vary depending on the operating fault or these sounds can be emitted in the form of impulses at repetition frequencies that depend on the operating fault.

The extinguisher identifying means 3220 comprise a reading device for reading an identifying code of an identifying element 266 on the extinguisher 260 allowing the extinguisher 260 to be identified. The extinguisher 260 is placed on its extinguisher mount 250 with the extinguisher identifying element 266 positioned facing the reading device of the identifying means 3220. At given times, an activation device 3225 can activate the reading device, which then inputs the extinguisher identifying code on the identifying element 266 of the extinguisher 260.

The given times can, for example, correspond to the times of requests, made by the central monitoring station 100, transmitted to the fire extinguishing devices 200 using radio waves.

The corresponding messages are received by the communications module 3210 of the extinguisher identifying device 3280. In response, the activation circuit activates the reading means of the reading device, which receives the identifying code of the identifying element 266 of the extinguisher 260 and transmits it to the communications module 3210, which retransmits it by radio to the central monitoring station 100.

In a particular embodiment the identifying code of the mount 250 of the extinguisher 260 can be transmitted to the control unit with the extinguisher identifying code 266. In another embodiment the mount 250 can be identified by the control unit 100 by means of the address of the source of the message containing the identifying code of the extinguisher 260.

In another embodiment, the times for reading the extinguisher identifying code by the reading device 3220 are preprogrammed. If, according to data received from the reading device, it appears that an extinguisher is missing or that the wrong type of extinguisher is at a given location on a given mount, the central monitoring station 100 can then trigger an alarm or transmit this information to a management system.

In another embodiment, the times for reading the extinguisher identifying code 266 by the reading device 3220 are preprogrammed and triggered in response to the removal of an extinguisher from its mount. If it appears that an extinguisher has not been placed back in the intended location or that it is not the right type of extinguisher that is in a given location on a given mount, the central monitoring station 100 can then trigger an alarm or transmit this information to a management system.

The extinguisher identifying element 266 can be of optical type, e.g. a barcode, a two-dimensional code, or even a digital tattooing type of code hidden in a piece of text on the extinguisher such as that known under the name Watermark, or a code associated to an image recognition algorithm. In these cases, the reading device 281 comprises an optical reading device such as a linear array of diodes, a two-dimensional optical sensor, a camera or a laser. These reading devices are equipped with image processing devices in a way known per se.

In another embodiment, the extinguisher identifying element is of electronic type. This can, for example, be realized by an assembly of switches, a matrix of diodes, a semiconductor type of memory, etc. In these cases, the reading device is of electronic type able to examine, for example, the open or closed condition of contacts, the diode matrix, or to read the semiconductor memory. This reading can be done either by using a direct electrical connection between the extinguisher identifying element and the reading means, or by using a radio, inductive or capacitive connection.

In another variant of the invention, the radio connection between a fire extinguishing device and the control unit can be achieved by using intermediate devices, which can make the radio connection possible, even if the distance between the fire extinguishing device and the control unit is too long to allow a direct connection.

It goes without saying, and is demonstrated moreover in the preceding description, that the invention is in no way restricted to those modes of application and embodiments that have been more particularly envisaged; on the contrary, it encompasses all the variants without in any way departing from the scope of the invention, such as it is defined by the claims.

1-33. (canceled)

34. A fire extinguishing device for a security system, comprising:
an extinguisher mount configured to support an extinguisher that can extinguish a fire;
an interface configured to link the fire extinguishing device to a security system control unit over a wireless connection;
a power supply device for supplying electricity to the fire extinguishing device from a power source;
a working condition verifier to detect an operating fault of the fire extinguishing device; and
a signaling device to signal the operating fault in the fire extinguishing device at the location of the fire extinguishing device;
wherein the working condition verifier is configured to detect a communications fault between the fire extinguishing device and the security system control unit over the wireless connection and wherein the signaling device is configured to signal said communications fault.

35. The device according to claim 34, wherein the working condition verifier is configured to detect a fault in the power supply from the power source to the fire extinguishing device and the signaling device is configured to signal said power supply fault.

36. The device according to claim 34, wherein the working condition verifier is configured to measure a parameter representative of a reception quality of a predefined radio verification signal from the security system control unit.

37. The device according to claim 34, wherein the working condition verifier is configured to measure a parameter representative of the quantity of power remaining in the power source.

38. The device according to claim 34, wherein the signaling device is configured to generate different signals depending on at least one of the following: a type or magnitude of the operating fault.

39. The device according to claim 34, further comprising a second signaling device for signaling the operating fault to the control unit.

40. The device according to claim 34, further comprising a detector for detecting a presence of at least one person in a vicinity of the fire extinguishing device; and wherein the signaling device is configured to signal a visible or audible alarm when the presence of at least one person is detected.

41. The device according to claim 34, further comprising a test triggering element to trigger an operating fault detection by the working condition verifier.

42. The device according to claim 34, further comprising an extinguisher identifier configured to obtain identifying data of the extinguisher at the extinguisher mount from an identifying element on the extinguisher; and an activation device configured to activate the extinguisher identifier in response to a predefined event.

43. The device according to claim 42, wherein the extinguisher identifier is configured to communicate with the identifying element of the extinguisher via a wireless connection to verify an identifying code for the extinguisher.

44. The device according to claim 34, wherein the extinguisher mount comprises a mount identifying element to supply a central monitoring station with identifying data of the mount to identify the mount.

45. The device according to claim 34, further comprising a detector for detecting an absence of an extinguisher from the extinguisher mount.

46. The device according to claim 45, wherein the signaling device is configured to signal said absence of the extinguisher at the location of the extinguisher identifying device.

47. A security system comprising at least one fire extinguishing device according to claim 34, and a central monitoring station configured to be connected to said at least one fire extinguishing device over a wireless connection.

48. A fire extinguishing device for a security system, comprising:
an extinguisher mount configured to support an extinguisher that can extinguish a fire;
an interface configured to connect the fire extinguishing device to a management device of the security system over at least a wireless connection;
a power supply device to supply electricity to the fire extinguishing device from a power source;
a communications verifier to detect an absence of communications from the management device during a predefined length of time; and
a signaling device to signal said absence of communications at the location of the fire extinguishing device.

49. A fire detection system comprising a management device configured to be linked via a wireless connection to at least one fire extinguishing device according to claim 48 and further comprising an interrogation device to send an interrogation signal to said at least one fire extinguishing device to obtain information representative of the operating condition of the fire extinguishing device.

50. A monitoring method for a security system comprising a management device and at least one fire extinguishing device according to claim 48 configured to communicate with the fire extinguishing device via a wireless connection, the method comprising the steps of:
verifying the wireless connection to detect an absence of communications from the management device to the fire extinguishing device during a predefined length of time; and
signaling said absence of communications at the location of the fire extinguishing device.

51. The method according to claim 50, comprising the steps of detecting reception of an interrogation signal from the management device; and, in response to the reception of the interrogation signal, transmitting information representative of the operating condition of the fire extinguishing device to the management device.

52. A fire extinguishing device for a security system, comprising:
an extinguisher mount configured to support an extinguisher that can extinguish a fire;
an interface configured to link the fire extinguishing device to a security system management device via a wireless connection;
a verifier to verify a quality of the wireless connection to verify, during an installation of the fire extinguishing device, the quality of the wireless connection between said fire extinguishing device and the management device; and
a signaling device to signal an indication of the quality of the wireless connection between said fire extinguishing device and the management device during the installation of said fire extinguishing device.

53. An installation method for at least one fire extinguishing device of a security system according to claim 52 in an area to be monitored, the security system comprising a management device configured to communicate with the fire extinguishing device via a wireless connection, the method comprising the steps of:
positioning the fire extinguishing device at a first location;
checking a quality of the wireless connection between the fire extinguishing device at the first location and the management device;
signaling, at the location of the fire extinguishing device, an indication of the quality of the wireless connection between said fire extinguishing device and the management device; and
moving the fire extinguishing device to a second location within the area to be monitored to check if the quality of the wireless connection can be improved.
